(19) United States
(12) Patent Application Publication
(10) Pub. No.: US 2010/0048403 A1
(43) Pub. Date: Feb. 25, 2010

(54) Method of inducing virus tolerance of plants

(75) Inventors: Dirk Voeste, Limburgerhof (DE); Egon Haden, Ludwigshafen (DE); Edson Begliomini, Sao Paulo (BR); Marco-Antonio Tavares-Rodrigues, Sao Paulo (BR)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/526,275

(22) PCT Filed: Feb. 12, 2008
(86) PCT No.: PCT/EP2008/051672

§ 371 Date: Aug. 7, 2009

(30) Foreign Application Priority Data
Feb. 14, 2007 (EP) 07102340.2

(51) Int. Cl. A01N 43/40; A01N 43/56; A01P 1/00

(52) U.S. Cl. 504/244; 504/280

(57) ABSTRACT

A method of inducing virus tolerance of plants which comprises treating the plants, the soil or seeds with an effective amount of an amide compound of the formula (I), where Ar is a substituted phenyl, pyridyl or 5-membered heterocyclic ring; M is an optionally substituted thienyl or phenyl ring; Q is a direct bond, oxygen, sulfur, SO, SO₂, C₁C₆-alkylene, C₂-C₆-alkenylene, a cyclo-propyleneor an anellated bicyclo[2.2.1]heptane ring; R¹ is hydrogen, alkyl, haloalkyl, optionally substituted phenyl or optionally substituted cycloalkyl.

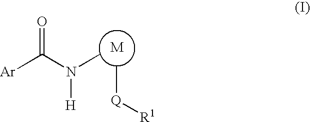

The present invention relates to a method of inducing virus tolerance of plants which comprises treating the plants, the soil or seeds, with an effective amount of an amide compound of formula I

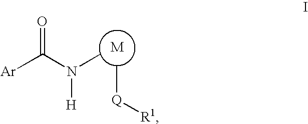

in which the substituents are as defined below:
Ar is a substituted phenyl, pyridyl or 5-membered heterocyclic ring containing two nitrogen atoms or one nitrogen and one sulfur atom as ring members and bearing one to three substituents, each selected from the group consisting of halogen, C₁-C₄-alkyl and C₁l-C₄-haloalkyl;
M is a thienyl ring or a phenyl ring optionally bearing a halogen atom;
Q is a direct bond, oxygen, sulfur, SO, SO₂, C₁-C₆-alkylene, C₂-C₆-alkenylene, a cyclopropylene or an anellated bicyclo[2.2.1]heptane ring;
R¹ is hydrogen, C₁-C₄-alkyl, C₁-C₄-haloalkyl, phenyl optionally substituted with one to three radicals independently selected from the group halogen and methyl, or is cycloalkyl optionally substituted with a methyl group.

A large number of representatives of the highly heterogeneous group of plant viruses (phytophages) are capable of attacking economically relevant plants; the symptoms of the damage range from morphological modifications to the death of the plants. The very many ways in which viruses are transmitted (for example mechanically via wounding, via seeds and pollen, or via vectors such as nematodes and insects), the problems of diagnosis and the lack of suitable active ingredients make the control of such viruses extraordinarily difficult; the emphasis is therefore on preventative and phytosanitary measures. Accordingly, preventing viral diseases in plants is an important aim in agriculture.

The search for methods for preventing viral diseases in plants has already yielded anti-viral active ingredients, some of which resemble nucleic acids. However, some of these substances generate mutants and inhibit the metabolism of nucleic acids and proteins in the host cells, giving rise to damage. In the field, these materials have only a small actual control effect.

DE-A 39 34 761 proposes polylysine and alkyldiethylene-triaminoacetic acids for preventing viral diseases of plants. EP-A 420 803 describes the immunizing effect of benzo-1,2,3-thiazole derivatives against various phytopathogenic microorganisms. WO-A 96/37493 discloses a similar effect of pyridylthiazoles.

DD 280 030 proposes sulfonic acid derivatives as agents for activating the resistance of crop plants and useful plants. PCT/EP2006/066337 teaches a similar activity of very specific phenyl derivatives and WO 03/070705 mentions that some of the compounds of formula I may be used against inter alia virus attack on plants.

However, the action of the known substances concerning virus defense is unsatisfactory in various aspects and WO 03/070705 provides neither a specific teaching with respect to virus nor any examples on how to apply the compounds.

WO 01/82701 discloses a method for inducing resitance of plants against virus infection by repeated application of strobilurin type active compounds. However, repeated application of fungicides may select resistant populations of the harmful fungi.

Accordingly, it was an object of the present invention to provide a method which can be used broadly, which does not damage the plants and which brings about effective immunization of the plants against viral diseases.

We have found that this object is achieved by the method defined at the outset. The active ingredients I are known as fungicides (cf., for example, EP-A 545 099, EP-A 589 301, EP-A 737682, EP-A 824099, WO 99/09013, WO 03/010149, WO 03/070705, WO 03/074491, WO 2004/005242, WO 2004/035589 and WO 2004/067515), or they can be prepared in the manner described therein.

The compounds I can be present in different crystal modifications, which may differ in biological activity.

The good compatibility with plants of the active ingredients of the formula I at the concentrations required for controlling plant diseases permits the treatment of aerial plant parts and also the treatment of propagation material and seed, and of the soil.

In the method according to the invention the active compounds are applied early in the growth period, long before first preventive fungicidal applications are made, and fungal infection pressure arises.

In one embodiment of the method according to the invention, the active ingredients are taken up by the plant through the roots, finally causing overall protection of the plant.

Thus, the protective action after carrying out the method according to the invention is not just found in those plant parts, which have been sprayed directly, but the tolerance to viral diseases of the entire plant is increased.

In a preferred embodiment of the method, the aerial plant parts are treated with a formulation of the active ingredient I.

In formula I, halogen is fluorine, chlorine, bromine or iodine, preferably fluorine or chlorine;

C₁-C₄-alkyl is methyl, ethyl, n-propyl, 1-methylethyl, n-butyl, 1-methylpropyl, 2-methylpropyl or 1,1-dimethylethyl, preferably methyl or ethyl;

C₁-C₄-haloalkyl is a partially or fully halogenated C₁-C₄-alkyl radical, where the halogen atom(s) is/are in particular fluorine, chlorine and/or bromine, i.e., for example, chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, heptafluoropropyl or nonafluorobutyl, in particular halomethyl, with particular preference CH₂—Cl, CH(Cl)₂, CH₂—F, CHF₂, CF₃, CHFCl, CF₂Cl or CF(Cl)₂, in particular CHF₂ or CF₃;

C₁-C₆-alkylene is, inter alia methylene, 1,1-ethylene, 1,2-ethylene, 1,1-propylene, 1,2-propylene, 1,3-propylene, 2,2-propylene, 1,1-butylene, 1,2-butylene, 1,3-butylene, 1,4-butylene, 2,2-butylene, 2,3-butylene, 2-methyl-1,1-propylene, 2-methyl-1,2-propylene, 2-methyl-1,3-propylene, 1,1-pentylene, 1,2-pentylene, 1,3-pentylene, 1,4-pentylene, 1,5-pentylene, 2,2-pentylene, 2,3-pentylene, 2,4-pentylene, 3,3-pentylene, 2-methyl-1,1-butylene, 2-methyl-1,2-butylene, 2-methyl-1,3-butylene, 2-methyl-1,4-butylene, 2-methyl-3,3-butylene, 2-methyl-3,4-butylene, 2-methyl-4,4-butylene, 2-ethyl-1,3-propylene, 2,2-dimethyl-1,1-propylene, 2,2-dimethyl-1,3-propylene, 1,1-hexylene, 1,2-hexylene, 1,3-hexylene, 1,4-hexylene, 1,5-hexylene, 1,6-hexylene, 2,2-hexylene, 2,3-hexylene, 2,4-hexylene, 2,5-hexylene, 3,3-hexylene, 3,4-hexylene, 2-methyl-1, 1-pentylene, 2-methyl-1,2-pentylene, 2-methyl-1,3-pentylene, 2-methyl-1,4-pentylene, 2-methyl-1,5-pentylene, 2-methyl-3,3-pentylene, 2-methyl-3,4-pentylene, 2-methyl-3,5-pentylene, 2-methyl-4,4-pentylene, 2-methyl-4,5-pentylene, 2-methyl-5,5-pentylene, 2-propyl-1,3-propylene, 3-methyl-1,1-pentylene, 3-methyl-1,2-pentylene, 3-methyl-1,3-pentylene, 3-methyl-1,4-pentylene, 3-methyl-1,5-pentylene, 3-methyl-2,2-pentylene, 3-methyl-2,3-pentylene, 3-methyl-2,4-pentylene, 2-ethyl-1,1-butylene, 2-ethyl-1,2-butylene, 2-ethyl-1,3-butylene, 2-ethyl-1,4-butylene, 2,3-dimethyl-1,1-butylene, 2,3-dimethyl-1,2-butylene, 2,3-dimethyl-1,3-butylene, 2,3-dimethyl-1,4-butylene, 2,3-dimethyl-2,3-butylene, 2-(2-propyl)-1,3-propylene, 2,2-dimethyl-1,1-butylene, 2,2-dimethyl-1,3-butylene, 2,2-dimethyl-1,4-butylene, 2,2-dimethyl-3,3-butylene, 2,2-dimethyl-3,4-butylene, 2,2-dimethyl-4,4-butylene and 2-methyl-2-ethyl-1,3-propylene, in particular 1,3-dimethylbutene.

C₂-C₆-alkenylene is, inter alia, ethenylene, prop-2-enylene, n-but-2-enylene, n-but-3-enylene, 1-methyl-prop-2-enylene or 2-methyl-prop-2-enylene, in particular prop-2-enylene, n-but-2-enylene and 1-methyl-prop-2-enylene.

In one aspect of the invention, preference is given to those compounds I wherein Ar is a phenyl radial (a)

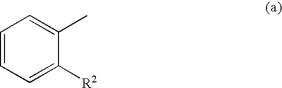

with R² being halogen or trifluoromethyl, preferably iodine.

In another aspect of the invention, preference is given to those compounds I wherein Ar is a pyridyl radial (b)

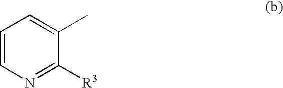

with R³ being halogen, preferably chlorine.

In still another aspect of the invention, preference is given to those compounds I wherein Ar is a pyrazolyl radical (c)

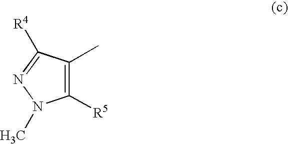

with R⁴ being C₁-C₄-alkyl or C₁-C₄-haloalkyl, preferably methyl or halomethyl, in particular methyl, difluoromethyl or trifluoromethyl, and R⁵ being hydrogen or halogen, preferably hydrogen or fluorine.

In still another aspect of the invention, preference is given to those compounds I wherein Ar is a thiazolyl radical (d)

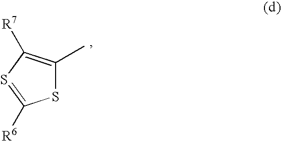

with R⁶ being hydrogen, halogen, C₁-C₄-alkyl or C₁-C₄-haloalkyl, preferably hydrogen, C₁-C₄-alkyl or C₁-C₄-haloalkyl, in particular hydrogen, methyl, difluoromethyl or trifluoromethyl. A particularly preferred meaning of R⁶ is C₁-C₄-haloalkyl, in particular difluoromethyl or trifluoromethyl.

R⁷ is preferably C₁-C₄-alkyl or C₁-C₄-haloalkyl, in particular methyl, difluoromethyl or trifluoromethyl.

Concerning M, the carboxamide group and Q must be in adjacent positions.

Furthermore, preference is given to those compounds I wherein M is a thienyl ring.

In another embodiment of the invention, preference is given to those compounds I wherein M is a phenyl ring bearing Q-R¹ as the only substituent.

In still another embodiment of the invention, preference is given to those compounds I wherein M is a phenyl ring bearing a halogen radical, preferably fluorine. The halogen radical is preferably located in para-position to the carbonylamino group.

In a preferred embodiment of the invention, Q is preferably a direct bond and R¹ is hydrogen.

In still another preferred embodiment of the invention, Q is a direct bond and R¹ is phenyl bearing one to three halogen atoms.

In another preferred embodiment of the invention, Q is C₁-C₆-alkylene and R¹ is hydrogen.

In still another preferred embodiment of the invention, Q is oxygen or sulfur and R¹ is C₁-C₄-haloalkyl.

In still another preferred embodiment of the invention, Q is cyclopropylene and R¹ is cyclopropyl, both rings preferably being in the trans stereoisomeric form.

In still another preferred embodiment of the invention, Q is an anellated bicyclo[2.2.1]heptane ring and R¹ is C₁-C₄-alkyl, in particular isopropyl.

Particularly preferred are
2-iodo-N-phenyl-benzamide, 2-chloro-N-(4′-chloro-biphenyl-2-yl)-nicotinamide, N-[2-(1,3-dimethylbutyl)-thiophen-3-yl]-3-trifluormethyl-1-methylpyrazol-4-yl-carboxamide,
N-(2-bicyclopropyl-2-yl-phenyl)-3-difluormethyl-1-methylpyrazol-4-ylcarboxamide,
N-(3′,4′,5′-trifluorobiphenyl-2-yl)-1,3-dimethylpyrazol-4-ylcarboxamide,
N-(3′,4′,5′-trifluorobiphenyl-2-yl)-1,3-dimethyl-5-fluoropyrazol-4-ylcarboxamide,
N-(3′,4′,5′-trifluorobiphenyl-2-yl)-5-chloro-1,3-dimethylpyrazol-4-ylcarboxamide,
N-(3′,4′,5′-trifluorobiphenyl-2-yl)-3-fluoromethyl-1-methylpyrazol-4-ylcarboxamide,
N-(3′,4′,5′-trifluorobiphenyl-2-yl)-3-(chlorofluoromethyl)-1-methylpyrazol-4-ylcarboxamide,
N-(3′,4′,5′-trifluorobiphenyl-2-yl)-3-difluoromethyl-1-methylpyrazol-4-ylcarboxamide,
N-(3′,4′,5′-trifluorobiphenyl-2-yl)-3-difluoromethyl-5-fluoro-1-methylpyrazol-4-ylcarboxamide,
N-(3′,4′,5′-trifluorobiphenyl-2-yl)-5-chloro-3-difluoromethyl-1-methylpyrazol-4-ylcarboxamide,
N-(3′,4′,5′-trifluorobiphenyl-2-yl)-3-(chlorodifluoromethyl)-1-methylpyrazol-4-ylcarboxamide,
N-(3′,4′,5′-trifluorobiphenyl-2-yl)-1-methyl-3-trifluoromethylpyrazol-4-ylcarboxamide,
N-(3′,4′,5′-trifluorobiphenyl-2-yl)-5-fluoro-1-methyl-3-trifluoromethylpyrazol-4-ylcarboxamide
N-(3′,4′,5′-trifluorobiphenyl-2-yl)-5-chloro-1-methyl-3-trifluoromethylpyrazol-4-ylcarboxamide,
N-(2′,4′,5′-trifluorobiphenyl-2-yl)-1,3-dimethylpyrazol-4-ylcarboxamide,
N-(2′,4′,5′-trifluorobiphenyl-2-yl)-1,3-dimethyl-5-fluoropyrazol-4-ylcarboxamide,
N-(2′,4′,5′-trifluorobiphenyl-2-yl)-5-chloro-1,3-dimethylpyrazol-4-ylcarboxamide,
N-(2′,4′,5′-trifluorobiphenyl-2-yl)-3-fluoromethyl-1-methylpyrazol-4-ylcarboxamide,
N-(2′,4′,5′-trifluorobiphenyl-2-yl)-3-(chlorofluoromethyl)-1-methylpyrazol-4-ylcarboxamide,
N-(2′,4′,5′-trifluorobiphenyl-2-yl)-3-difluoromethyl-1-methylpyrazol-4-ylcarboxamide,
N-(2′,4′,5′-trifluorobiphenyl-2-yl)-3-difluoromethyl-5-fluoro-1-methylpyrazol-4-ylcarboxamide,
N-(2′,4′,5′-trifluorobiphenyl-2-yl)-5-chloro-3-difluoromethyl-1-methylpyrazol-4-ylcarboxamide,
N-(2′,4′,5′-trifluorobiphenyl-2-yl)-3-(chlorodifluoromethyl)-1-methylpyrazol-4-ylcarboxamide,
N-(2′,4′,5′-trifluorobiphenyl-2-yl)-1-methyl-3-trifluoromethylpyrazol-4-ylcarboxamide,
N-(2′,4′,5′-trifluorobiphenyl-2-yl)-5-fluoro-1-methyl-3-trifluoromethylpyrazol-4-ylcarboxamide,
N-(2′,4′,5′-trifluorobiphenyl-2-yl)-5-chloro-1-methyl-3-trifluoromethylpyrazol-4-ylcarboxamide,
N-(3′,4′-dichloro-3-fluorobiphenyl-2-yl)-1-methyl-3-trifluoromethyl-1H-pyrazole-4-carboxamide,
N-(3′,4′-dichloro-3-fluorobiphenyl-2-yl)-1-methyl-3-difluoromethyl-1H-pyrazole-4-carboxamide,
N-(3′,4′-difluoro-3-fluorobiphenyl-2-yl)-1-methyl-3-trifluoromethyl-1H-pyrazole-4-carboxamide,
N-(3′,4′-difluoro-3-fluorobiphenyl-2-yl)-1-methyl-3-difluoromethyl-1H-pyrazole-4-carboxamide,
N-(3′-chloro-4′-fluoro-3-fluorobiphenyl-2-yl)-1-methyl-3-difluoromethyl-1H-pyrazole-4-carboxamide,

N-(3′,4′-dichloro-4-fluorobiphenyl-2-yl)-1-methyl-3-trifluoromethyl-1H-pyrazole-4-carboxamide,
N-(3′,4′-difluoro-4-fluorobiphenyl-2-yl)-1-methyl-3-trifluoromethyl-1H-pyrazole-4-carboxamide,
N-(3′,4′-dichloro-4-fluorobiphenyl-2-yl)-1-methyl-3-difluoromethyl-1H-pyrazole-4-carboxamide,
N-(3′,4′-difluoro-4-fluorobiphenyl-2-yl)-1-methyl-3-difluoromethyl-1H-pyrazole-4-carboxamide,
N-(3′-chloro-4′-fluoro-4-fluorobiphenyl-2-yl)-1-methyl-3-difluoromethyl-1H-pyrazole-4-carboxamide,

N-(3′,4′-dichloro-5-fluorobiphenyl-2-yl)-1-methyl-3-trifluoromethyl-1H-pyrazole-4-carboxamide,
N-(3′,4′-difluoro-5-fluorobiphenyl-2-yl)-1-methyl-3-trifluoromethyl-1H-pyrazole-4-carboxamide,
N-(3′,4′-dichloro-5-fluorobiphenyl-2-yl)-1-methyl-3-difluoromethyl-1H-pyrazole-4-carboxamide,
N-(3′,4′-difluoro-5-fluorobiphenyl-2-yl)-1-methyl-3-difluoromethyl-1H-pyrazole-4-carboxamide,
N-(3′,4′-dichloro-5-fluorobiphenyl-2-yl)-1,3-dimethyl-1H-pyrazole-4-carboxamide,
N-(3′-chloro-4′-fluoro-5-fluorobiphenyl-2-yl)-1-methyl-3-difluoromethyl-1H-pyrazole-4-carboxamide,
N-(4′-fluoro-4-fluorobiphenyl-2-yl)-1-methyl-3-trifluoromethyl-1H-pyrazole-4-carboxamide,
N-(4′-fluoro-5-fluorobiphenyl-2-yl)-1-methyl-3-trifluoromethyl-1H-pyrazole-4-carboxamide,
N-(4′-chloro-5-fluorobiphenyl-2-yl)-1-methyl-3-trifluoromethyl-1H-pyrazole-4-carboxamide,
N-(4′-methyl-5-fluorobiphenyl-2-yl)-1-methyl-3-trifluoromethyl-1H-pyrazole-4-carboxamide,
N-(4′-fluoro-5-fluorobiphenyl-2-yl)-1,3-dimethyl-1H-pyrazole-4-carboxamide,
N-(4′-chloro-5-fluorobiphenyl-2-yl)-1,3-dimethyl-1H-pyrazole-4-carboxamide,
N-(4′-methyl-5-fluorobiphenyl-2-yl)-1,3-dimethyl-1H-pyrazole-4-carboxamide,
N-(4′-fluoro-6-fluorobiphenyl-2-yl)-1-methyl-3-trifluoromethyl-1H-pyrazole-4-carboxamide,
N-(4′-chloro-6-fluorobiphenyl-2-yl)-1-methyl-3-trifluoromethyl-1H-pyrazole-4-carboxamide,
N-[2-(1,1,2,3,3,3-hexafluoropropoxy)-phenyl]-3-difluoromethyl-1-methyl-1H-pyrazole-4-carboxamide,
N-[4′-(trifluoromethylthio)-biphenyl-2-yl]-3-difluoromethyl-1-methyl-1H-pyrazole-4-carboxamide,
N-[4′-(trifluoromethylthio)-biphenyl-2-yl]-1-methyl-3-trifluoromethyl-1-methyl-1H-pyrazole-4-carboxamide,
3-(difluoromethyl)-1-methyl-N-[1,2,3,4-tetrahydro-9-(1-methylethyl)-1,4-methanonaphthalen-5-yl]-1H-pyrazole-4-carboxamide (common name: isopyrazam).

The compounds I increase the tolerance of plants to viruses. They are especially important for controlling viruses on diverse crop plants such as tobacco, barley, cucumber, potatoes and beet, and on the seeds of these plants.

The inventive method is useful to induce tolerance in plants against viruses of various families, such as Avsunviroidae, Bromoviridae, Closteroviridae, Flexiviridae, Geminiviridae, Luteoviridae, Nanoviridae, Partitiviridae, Pospiviroidae, Potyviridae, Reoviridae, Mononegavirales, Rhabdoviridae, Sequiviridae, Tombusviridae and Tymoviridae.

It is particularly suitable to control the following genus: Benyvirus, Ilarvirus, Cucumovirus, Oleavirus, Tospovirus, Caulimovirus, Soymovirus, Cavemovirus, Petuvirus; Closterovirus; Comovirus; Crinivirus, Ampelovirus, Fabavirus, Nepovirus, Allexivirus, Manadrivirus, Carlavirus, Capillovirus, Foveavirus, Potexvirus, Trichovirus, Vitivirus, Furovirus, Mastrevirus, Curtovirus, Begomovirus, Hordeivirus, Idaeovirus, Luteovirus, Polerovirus, Enamovirus, Nanovirus, Ophiovirus, Ourmiavirus, Alphacryptovirus, Betacryptovirus, Pecluvirus, Pomovirus, Potyvirus, Rymovirus, Bymovirus, Macluravirus, Ipomovirus, Tritimovirus, Fijivirus, Phytoreovirus, Oryzavirus, Cytorhabdovirus, Nucleorhabdovirus, Sequivirus, Waikavirus, Sobemovirus, Tenuivirus, Tobamovirus, Tobravirus, Tombusvirus, Carmovirus, Necrovirus, Dianthovirus, Machlomovirus, Avenavirus, Tymovirus, Marafivirus, Maculavirus, Umbravirus, Varicosavirus, Pospiviroid, Hostuviroid, Cocadviroid, Apscaviroid, Coleviroid, Avsuniviroid and Pelamoviroid.

More particularly, the inventive method is useful for controlling the following species: Tobacco streak virus, Cucumber mosaic virus, Tomato spotted wilt virus, Soybean chlorotic mottle virus, Broad bean wilt virus 1, Tobacco ringspot virus, Potato virus X, Soil-borne wheat mosaic virus, Barley stripe mosaic virus, Potato leafroll virus, Ourmia melon virus, Peanut clump virus, Potato mop-top virus, Potato virus Y, Barley yellow mosaic virus, Wheat streak mosaic virus, Potato yellow dwarf virus, Tobacco necrosis virus satellite, Southern bean mosaic virus, Tobacco mosaic virus, Tobacco rattle virus, Tomato bushy stunt virus, Tobacco necrosis virus A, Maize chlorotic mottle virus, Maize rayado fino virus, and Potato spindle tuber viroid.

Specifically, they are suitable for controlling the following plant diseases:
in tobacco, the tobacco mosaic virus and the tobacco necrosis virus,
in beans, the bean common mosaic virus and the bean yellow mosaic virus,
in barley, the barley stripe mosaic virus and the barley yellow dwarf virus (DYDV),
in cucumbers, the cucumber green mottle mosaic virus and the cucumber mosaic virus,
in potatoes, the potato X virus and the potato y virus,
in beet, rhizomania and beet mild yellowing virus.

The plants or seed treated with compounds I may by wildlife types, plants or seed obtained by breeding and transgenic plants as well as their seed.

Application of the inventive combinations to useful plants may also lead to an increase in the crop yield.

The application of the compound I preferably is made during the first six weeks, preferably four weeks of the growth period of the plants, long before first protective application against fungi usually is made.

The plant is treated before infection takes place, preferably several weeks to one week before the expected virus attack. During such timeframe one to 10 applications are carried out. A markedly reduced susceptibility of the plant to viral diseases is observed.

In case of vegetables and field crops the active ingredients are preferably applied shortly after germination of the plants, especially within the first four weeks after germination. In case of fruits and other perennial plants the first application is made before begin or within the first four weeks of the growth period. In all cases best efficacy is observed, when the application is repeated every 10 to 20 days.

The method according to the invention is preferably carried out as foliar application when applied to fruit and vegetables, such as potatoes, tomatoes, cucurbits, preferably cucumbers, melons, watermelons, garlic, onions, and lettuce. Preferably more than two applications, and up to 10 applications during a season are carried out.

The method according to the invention is preferably carried out as foliar application when applied to fruits, such as apples, stone fruits, citrus, advocados, papaya and other tropic fruits. Preferably more than two applications, and up to 5 applications during a season are carried out.

The method of the invention can also be applied to field crops, such as soybeans, corn, cotton, tobacco, common beans, wheat, barley, peas, and others. In relation to these crops the method is preferably applied by treating the seeds or the plants. The plants are preferably treated with two to three applications.

The amide compound of the formula I may also be applied on the presence of a further fungicidally active compounds II selected from the following groups A) to F):
A) azoles selected from the group consisting of azaconazole, bitertanol, bromuconazole, cypro-conazole, difenoconazole, diniconazole, diniconazole-M, enilconazole, epoxiconazole, fluquin-conazole, fenbuconazole, flusilazole, flutriafol, hexaconazole, imibenconazole, ipconazole, metconazole, myclobutanil, penconazole, propiconazole, prothiocon-azole, simeconazole, triadimefon, triadimenol, tebuconazole, tetraconazole, triti-conazole, prochloraz, pefurazoate, imazalil, triflumizole, cyazofamid, benomyl, carbendazim, thiabendazole, fuberidazole, ethaboxam, etridiazole, hymexazole oxpoconazol, paclobutrazol, uniconazol, 1-(4-chloro-phenyl)-2-([1,2,4]triazol-1-yl)-cycloheptanol and imazalil-sulfphate;
B) strobilurins selected from the group consisting of azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl(2-chloro-5-[1-(3-methylbenzyloxyimino)ethyl]benzyl)carbamate, methyl(2-chloro-5-[1-(6-methyl-pyridin-2-ylmethoxyimino)ethyl]benzyl)carbamate, methyl 2-(ortho-(2,5-dimethylphenyloxymethylene)phenyl)-3-methoxyacrylate, 2-(2-(6-(3-chloro-2-methylphenoxy)-5-fluoro-pyrimidin-4-yloxy)-phenyl)-2-methoxyimino-N-methyl-acetamide and 3-methoxy-2-(2-(N-(4-methoxy-phenyl)-cyclopropane-carboximidoylsulfanylmethyl)-phenyl)-acrylic acid methyl ester;
C) carboxamides selected from the group consisting of carboxin, benalaxyl, benalaxyl-M, fenhexamid, flutolanil, fluopyram, furametpyr, mepronil, metalaxyl, mefenoxam, ofurace, oxadixyl, oxycarboxin, penthiopyrad, thifluzamide, tiadinil, 3,4-dichloro-N-(2-cyanophenyl)isothiazole-5-carboxamide, penthiopyrad, dimethomorph, flumorph, flumetover, fluopicolide (picobenzamid), zoxamide, carpropamid, diclocymet, mandipropamid, N-(2-(4-[3-(4-chlorophenyl)prop-2-ynyloxy]-3-ethoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide, methyl 3-(4-chlorophenyl)-3-(2-isopropoxycarbonylamino-3-methylbutyrylamino)-propionate, N-(4′-bromobiphenyl-2-yl)-4-difluoromethyl-2-methylthiazole-5-carbox-amide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3′,4′-dichloro-4-fluorobiphenyl-2-yl)-3-difluoromethyl-1-methylpyrazole-4-carboxamide, N-(2-cyanophenyl)-3,4-dichloroisothiazole-5-carboxamide, 2-amino-4-methyl-thiazole-5-carboxylic acid anilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxylic acid amide, N-(4′-chloro-3′,5-difluoro-biphenyl-2-yl)-3-difluoromethyl-1-methyl-1H-pyrazole-4-carboxylic acid amide, N-(4′-chloro-3′,5-difluoro-biphenyl-2-yl)-3-trifluoromethyl-1-methyl-1H-pyrazole-4-carboxylic acid amide, N-(3′,4′-dichloro-5-fluoro-biphenyl-2-yl)-3-trifluoromethyl-1-methyl-1H-pyrazole-4-carboxylic acid amide, N-(3′,5-difluoro-4′-methyl-biphenyl-2-yl)-3-difluoromethyl-1-methyl-1H-pyrazole-4-carboxylic acid amide, N-(3′,5-difluoro-4′-methyl-biphenyl-2-yl)-3-trifluoromethyl-1-methyl-1H-pyrazole-4-carboxylic acid amide, N-(cis-2-bicyclopropyl-2-yl-phenyl)-3-di-fluoromethyl-1-methyl-1H-pyrazole-4-carboxylic acid amide, N-(trans-2-bi-cyclopropyl-2-yl-phenyl)-3-difluoromethyl-1-methyl-1H-pyrazole-4-carboxylic acid amide, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxylic acid amide and isotianil;
D) heterocyclic compounds selected from the group consisting of fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, probenazole, 5-chloro-7-(4-methylpiperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen, N,N-dimethyl-3-(3-bromo-6-fluoro-2-methylindole-1-sulfonyl)-[1,2,4]triazole-1-sulfonamide2,3,5,6-tetra-chloro-4-methanesulfonyl-pyridine, 3,4,5-trichloropyridine-2,6-di-carbonitrile, N-(1-(5-bromo-3-chloro-pyridin-2-yl)-ethyl)-2,4-dichloronicotinamide, N-[(5-bromo-3-chloro-pyridin-2-yl)-methyl]-2,4-dichloro-nicotinamide, diflumetorim, nitrapyrin, dodemorph-acetate, fluoroimid, blasticidin-S, chinomethionat, debacarb, difenzoquat, difenzoquat-methylsulphat, oxolinic acid, piperalin, 3-[5-(4-chloro-phenyl)-2,3-dimethyl-isoxazolidin-3-yl]-pyridine

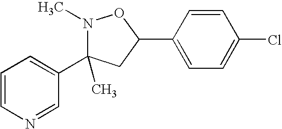

and 5-amino-2-isopropyl-4-ortho-tolyl-pyrazol-3-on-1-thiocarboxylic acid allyl ester

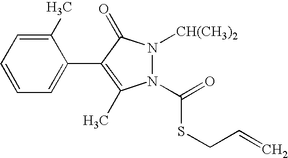

E) carbamates selected from the group consisting of mancozeb, maneb, metam, metiram, ferbam, propineb, pyribencarb, thiram, zineb, ziram, diethofencarb, iprovalicarb, flubenthiavalicarb, methasulphocarb, propamocarb, propamocarb hydrochloride, 4-fluorophenyl N-(1-(1-(4-cyanophenyl)ethane-sulfonyl)but-2-yl)carbamate, methyl 3-(4-chlorophenyl)-3-(2-isopropoxycarbonyl-amino-3-methylbutyrylamino)propanoate and carbamate oxime ethers of the formula III

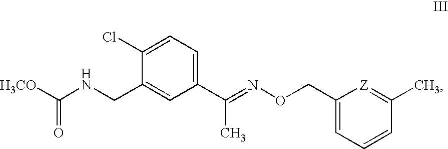

in which Z is N or CH;
F) other fungicides selected from the group consisting of guanidine, dodine, dodine free base, iminoctadine, iminoctadine-triacetate, iminoctadine-tris(albesilate), guazatine, guazatine-acetate, antibiotics: kasugamycin, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts such as fentin acetate, organophosphorus compounds: edifenphos, iprobenfos, fosetyl, fosetyl-aluminum, phosphorous acid and its salts, pyrazophos, tolclofos-methyl, organochlorine compounds: chlorothalonil, dichlofluanid, flusulfamide, hexachlorbenzene, phthalide, pencycuron, quintozene, thiophanate-methyl, tolylfluanid, inorganic active compounds: Bordeaux mixture, copper acetate, copper hydroxide, copper oxychloride, basic copper sulfate, sulfur, others: cyflufenamid, cymoxanil, dimethirimol, ethirimol, furalaxyl, metrafenone, spiroxamine, kasugamycin-hydrochlorid-hydrat, dichlorophen, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxin-copper, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methyl formamidine and N′-(5-difluormethyl-2-methyl-4-(3-trimethylsilanyl-propoxy)-phenyl)-N-ethyl-N-methyl formamidine;
G) plant growth regulators selected from the group consisting of clofibric acid, 4-CPA (4-chlorophenoxyacetic acid), 2,4-D, 2,4-DB, 2,4-DEP, dichlorprop, fenoprop, IAA (indole-3-acetic acid), IBA (4-indol-3-ylbutyric acid), naphthaleneacetamide, α-naphthaleneacetic acid, 1-naphthol, naphthoxyacetic acid, potassium naphthenate, sodium naphthenate, 2,4,5-T, 2iP (N-(3-methylbut-2-enyl)-1H-purin-6-amine), 6-benzylaminopurine (6-BA), 2,6-dimethylpuridine (N-oxide-2,6-lultidine), benzyladenine, kinetin, zeatin, calcium cyanamide, dimethipin, endothal, ethephon, merphos, metoxuron, pentachlorophenol and its salts, thidiazuron, tribufos, aviglycine, 1-methylcyclopropene, ACC (1-aminocyclopropanecarboxylic acid), etacelasil, ethephon, glyoxime, gibberellins, gibberellic acid, abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham, 2,3,5-tri-iodobenzoic acid, chlorfluren, chlorflurenol, dichlorflurenol, flurenol, chlormequat, daminozide, flurprimidol, mefluidide, paclobutrazol, tetcyclacis, uniconazole, brassinolide, forchlorfenuron, hymexazol, amidochlor, benzofluor, buminafos, carvone, ciobutide, clofencet, cloxyfonac, cyanamide, cyclanilide, cycloheximide, cyprosulfamide, epocholeone, ethychlozate, ethylene, fenridazon, fluprimidol, heptopargil, holosulf, inabenfide, karetazan, lead arsenate, methasulfocarb, prohexadione (prohexadione calcium), pydanon, sintofen, triapenthenol and trinexapac (trinexapac-ethyl).

The active compounds II mentioned above, their preparation and their action against harmful fungi are generally known (cf., for example, http://www.hclrss.demon.co.uk/index.html); they are commercially available.

Preference is given to mixtures of compounds I with an active compound II selected from the group of the azoles A).

Preference is also given to mixtures of compounds I with an active compound II selected from the group of the strobilurins B).

Preference is given to mixtures of compounds I with an active compound II selected from the group of the carboxamides C).

Preference is furthermore also given to mixtures of compounds I with an active compound II selected from the group of the heterocyclic compounds D).

Preference is furthermore also given to mixtures of compounds I with an active compound II selected from the group of the carbamates E).

Preference is furthermore also given to mixtures of compounds I with an active compound II selected from the group of the other fungicides F).

Preference is furthermore also given to mixtures of compounds I with an active compound II selected from the group of the plant growth regulators G).

Preference is furthermore also given to mixtures of compounds I with an active compound II from the group of the azoles A) selected from the group consisting of cyproconazole, difenoconazole, epoxiconazole, fluquinconazole, flusilazole, flutriafol, metconazole, myclobutanil, penconazole, propiconazole, prothioconazole, triadimefon, triadimenol, tebuconazole, tetraconazole, triticonazole, prochloraz, cyazofamid, benomyl, carbendazim and ethaboxam.

Particular preference is also given to mixtures of compounds I with an active compound II from the group of the azoles A) selected from the group consisting of cyproconazole, difenoconazole, epoxiconazole, fluquinconazole, flusilazole, flutriafol, metconazole, myclobutanil, propiconazole, prothioconazole, triadimefon, triadimenol, tebuconazole, tetraconazole, triticonazole, prochloraz, cyazofamid, benomyl and carbendazim.

Very particular preference is also given to mixtures of compounds I with an active compound II from the group of the azoles A) selected from the group consisting of epoxiconazole, fluquinconazole, flutriafol, metconazole, tebuconazole, triticonazole, prochloraz and carbendazim.

Preference is also given to mixtures of compounds I with at least one active compound II from the group of the strobilurins B) selected from the group consisting of azoxystrobin, dimoxystrobin, fluoxastrobin, kresoxim-methyl, orysastrobin, picoxystrobin, pyraclostrobin and trifloxystrobin.

Particular preference is also given to mixtures of compounds I with an active compound II from the group of the strobilurins B) selected from the group consisting of kresoxim-methyl, orysastrobin and pyraclostrobin.

Very particular preference is also given to mixtures of compounds I with pyraclostrobin.

Preference is also given to mixtures of compounds I with an active compound II from the group of the carboxamides C) selected from the group consisting of fenhexamid, metalaxyl, mefenoxam, ofurace, dimethomorph, flumorph, fluopicolide (picobenzamid), zoxamide, carpropamid and mandipropamid.

Particular preference is also given to mixtures of compounds I with an active compound II from the group of the carboxamides C) selected from the group consisting of fenhexamid, metalaxyl, mefenoxam, ofurace, dimethomorph, zoxamide and carpropamid.

Preference is also given to mixtures of compounds I with an active compound II from the group of the heterocyclic compounds D) selected from the group consisting of fluazinam, cyprodinil, fenarimol, mepanipyrim, pyrimethanil, triforine, fludioxonil, dodemorph, fenpropimorph, tridemorph, fenpropidin, iprodione, vinclozolin, famoxadone, fenamidone, probenazole, 5-chloro-7-(4-methylpiperidin-1-yl)-6-(2,4,6-trifluorophenyl)-[1,2,4]triazolo[1,5-a]pyrimidine, proquinazid, acibenzolar-S-methyl, captafol, folpet, fenoxanil and quinoxyfen, in particular fluazinam, cyprodinil, fenarimol, mepanipyrim, pyrimethanil, triforine, fludioxonil, dodemorph, fenpropimorph, tridemorph, fenpropidin, iprodione, vinclozolin, famoxadone, fenamidone, probenazole, proquinazid, acibenzolar-S-methyl, captafol, folpet, fenoxanil and quinoxyfen.

Particular preference is also given to mixtures of compounds I with an active compound II from the group of the heterocyclic compounds D) selected from the group consisting of pyrimethanil, dodemorph, fenpropimorph, tridemorph, iprodione, vinclozolin, 5-chloro-7-(4-methylpiperidin-1-yl)-6-(2,4,6-trifluorophenyl)-[1,2,4]triazolo[1,5-a]pyrimidine and quinoxyfen, in particular pyrimethanil, dodemorph, fenpropimorph, tridemorph, iprodione, vinclozolin and quinoxyfen.

Preference is also given to mixtures of compounds I with at least one active compound II from the group of the carbamates E) selected from the group consisting of mancozeb, metiram, propineb, thiram, iprovalicarb, flubenthiavalicarb and propamocarb.

Particular preference is also given to mixtures of compounds I with an active compound II from the group of the carbamates E) selected from the group consisting of mancozeb and metiram.

Preference is also given to mixtures of compounds I with an active compound II from the group of the other fungicides F) selected from the group consisting of dithianon, fentin salts, such as fentin acetate, fosetyl, fosetyl-aluminum, phosphorous acid and its salts, chlorothalonil, dichlofluanid, thiophanate-methyl, copper acetate, copper hydroxide, copper oxychloride, basic copper sulfate, sulfur, cymoxanil, metrafenone and spiroxamine.

Particular preference is also given to mixtures of compounds I with an active compound II from the group of the other fungicides F) selected from the group consisting of phosphorous acid and its salts, chlorothalonil and metrafenone.

Preference is also given to mixtures of a compound of the formula I with at least one acitve compound selected from the group of the G) plant growth regulators selected from the group consisting of abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6 benzyladenine, prohexadione (prohexadione calcium), prohydrojasmon, thidiazuron, triapenthenol, tributyl phosphorotrithioate, 2,3,5-triiodobenzoic acid and trinexapac (trinexapac-ethyl).

The compound(s) I and at least one of the active compounds 11 can be applied simultaneously, that is jointly or separately, or in succession, the sequence, in the case of separate application, generally not having any effect on the result of the control measures.

When preparing the mixtures, it is preferred to employ the pure active compounds I and II, to which further compounds active against harmful fungi or other pests, such as insects, arachnids or nematodes, or else herbicidal or growth-regulating active compounds or fertilizers can be added.

Usually, mixtures of a compound I and one active compound II are employed. However, in certain cases mixtures of at least one compound I with two or, if appropriate, more active components may be advantageous.

The compound(s) I and the active compound(s) II are usually employed in a weight ratio of from 100:1 to 1:100, preferably from 20:1 to 1:20, in particular from 10:1 to 1:10.

The further active components are, if desired, added in a ratio of from 20:1 to 1:20 to the compound I.

For use in crop protection, the application rates are between 0.01 and 2.0 kg, preferably up to 1.0 kg of active ingredient per hectare, depending on the type of pathogen and the plant species.

In the treatment of seed, amounts of from 0.001 to 0.1 g, preferably 0.01 to 0.05 g, of active ingredient are generally required per kilogram of seed.

The compounds I can be converted into the formulations conventionally used for fungicides, for example solutions, emulsions, suspensions, dusts, powders, pastes and granules. The use form depends on the particular purpose; in any case, it should ensure fine and uniform distribution of the compound according to the invention.

Best results are obtained when a formulation is used which supports the transport of the active compounds into the plants, and the distribution within the entire plant in the sap.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, N.Y., 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, anti-foaming agents, anti-freezing agents.

Examples of suitable solvents are water, aromatic solvents (for example Solvesso® products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used.

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

Suitable preservatives are for example dichlorophen und enzylalkoholhemiformal.

Seed Treatment formulations may additionally comprise binders and optionally colorants.

Binders can be added to improve the adhesion of the active materials on the seeds after treatment. Suitable binders are block copolymers EO/PO surfactants but also polyvinylalcoholsl, polyvinyl pyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

For seed treatment purposes, respective formulations can be diluted 2-10 fold leading to concentrations in the ready to use preparations of 0.01 to 60% by weight active compound by weight, preferably 0.1 to 40% by weight.

The compounds I can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound may also be used successfully in the ultra-low-volume process (ULV), it being possible to apply formulations comprising over 95% by weight of active compound, or even to apply the active compound without additives.

The following are examples of formulations:

1. Products for dilution with water for foliar applications.

A) Water-Soluble Concentrates (SL, LS)

10 parts by weight of the active compound(s) I are dissolved in 90 parts by weight of water or a water-soluble solvent. As an alternative, wetters or other auxiliaries are added. The active compound(s) dissolves upon dilution with water, whereby a formulation with 10 % (w/w) of active compound(s) is obtained.

B) Dispersible Concentrates (DC)

20 parts by weight of the active compound(s) I are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

C) Emulsifiable Concentrates (EC)

15 parts by weight of the active compound(s) I are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

D) Emulsions (EW, EO, ES)

25 parts by weight of the active compound(s) I are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

E) Suspensions (SC, OD, FS)

In an agitated ball mill, 20 parts by weight of the active compound(s) I are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

F) Water-Dispersible Granules and Water-Soluble Granules (WG, SG)

50 parts by weight of the active compound(s) I are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

G) Water-Dispersible Powders and Water-Soluble Powders (WP, SP, SS, WS)

75 parts by weight of the active compound(s) I are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

For seed treatment purposes, such products A) to G) may be applied to the seed diluted or undiluted.

2. Products to be applied undiluted for foliar applications.

H) Dustable Powders (DP, DS)

5 parts by weight of the active compound(s) I are ground finely and mixed intimately with 95 parts by weight of finely divided kaolin. This gives a dustable product having 5% (w/w) of active compound(s)

J) Granules (GR, FG, GG, MG)

0.5 part by weight of the active compound(s) I is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

K) ULV Solutions (UL)

10 parts by weight of the active compound(s) I are dissolved in 90 parts by weight of an organic solvent, for example xylene. This gives a product having 10% (w/w) of active compound(s), which is applied undiluted for foliar use.

For seed treatment purposes, such products H) to K) may be applied to the seed diluted.

In the treatment of seed, application rates of mixture are generally from 1 to 1000 g per 100 kg of seed, preferably from 1 to 750 g per 100 kg, in particular from 5 to 500 g per 100 kg of seed.

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulation can be applied to the seed diluted or undiluted. Application to the seeds is carried out before sowing, either directly on the seeds.

In a preferred embodiment a FS formulation is used for seed treatment. Typcially, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water.

The note mentioning the effect of the active ingredients I in inducing resistance to viruses may be present as a label on the packaging or in product data sheets. The note may also be present in the case of preparations which can be used in combination with the active ingredients I.

The induction of resistance may also constitute an indication which may be the subject of official approval of the active ingredients I.

The action of the amide compounds I with respect to the improvement of plant tolerance to viral infections was demonstrated by the following experiments.

### USE EXAMPLE 1

### Cucumber Green Mottle Mosaic Virus (CGMMV)

The experiment tested the effect of boscalid (as Filan®) on the symptom expression of CGMMV in cucumbers. Cucumber plants were treated with Filan or water 7 days before mechanical inoculation with CGMMV. Filan® was applied at 500 g in 200 litres water. Sprays were applied as a fine spray to run-off.

The experiment consisted of 5 plants per each treatment, with three replicates arranged randomly after fungicide treatment, but before inoculation. Plants were then inoculated in situ. Plants were mechanically inoculated at the 4-6 true leaf stage. Cucumber leaves showing symptoms and confirmed by CSL as infected with CGMMV were used as the source of inoculum. Several infected leaves were crushed in a plastic bag with a small amount of distilled water to extract the sap. This sap was then gently rubbed onto the second lowest green leaf of each plant in the experiment. Symptoms of CGMMV were assessed at intervals following inoculation.

Results

| | | Number of leaves with | Number of leaves with |
|---|---|---|---|
| | | symtoms, 8 days after | symtoms, 33 days after |
| Substance | Application rate | inoculation (Average) | inoculation (Average) |
| untreated | — | 2.4 | 7.4 |
| Boscalid | 500 g product in | 0.8 | 4.4 |
| (as Filan ®) | 200 litres water | | |

1-16. (canceled)

17. A method of inducing virus tolerance of plants which comprises treating the plants, the soil or seeds, with an effective amount of an amide compound of formula I 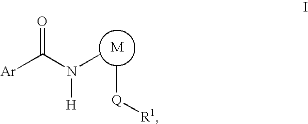
in which the substituents are as defined below:
Ar is a substituted phenyl, pyridyl or 5-membered heterocyclic ring containing two nitrogen atoms or one nitrogen and one sulfur atom as ring members and bearing one to three substituents, each selected from the group consisting of halogen, C₁-C₄-alkyl and C₁-C₄-haloalkyl;
M is a thienyl ring or a phenyl ring optionally bearing a halogen atom;
Q is a direct bond, oxygen, sulfur, SO, SO₂, C₁-C₆-alkylene, C₂-C₆-alkenylene, a cyclopropylene or an anellated bicyclo[2.2.1]heptane ring; and
R¹ is hydrogen, C₁-C₄-alkyl, C₁-C₄-haloalkyl, phenyl optionally substituted with one to three radicals independently selected from the group halogen and methyl, or is cycloalkyl optionally substituted with a methyl group.

18. The method of claim 17, wherein Ar is a phenyl, pyridyl, pyrazolyl, or thiazolyl radical (a), (b), (c) or (d) 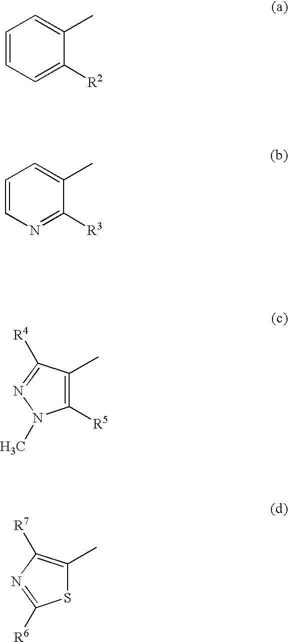
wherein
R² is halogen or trifluoromethyl;
R³ is halogen;
R⁴ is C₁-C₄-alkyl or C₁-C₄-haloalkyl;
R⁵ is hydrogen or halogen;
R⁶ is hydrogen, halogen, C₁-C₄-alkyl or C₁-C₄-haloalkyl; and
R⁷ is C₁-C₄-alkyl or C₁-C₄-haloalkyl.

19. The method of claim 17, wherein M is phenyl or a thienyl ring, Q is C₁-C₆-alkylene and R¹ is hydrogen.

20. The method of claim 17, wherein M is phenyl, Q is cyclopropylene and R¹ is cyclopropyl optionally bearing a methyl group.

21. The method of claim 17, wherein M is phenyl, Q is a bond and R¹ is phenyl bearing one to three radicals independently selected from the group methyl and halogen.

22. The method of claim 17, wherein M is phenyl substituted by a halogen atom, Q is a bond and R¹ is phenyl bearing one to three radicals independently selected from the group methyl and halogen.

23. The method of claim 17, wherein the amide compound of formula I is
2-iodo-N-phenyl-benzamide, 2-chloro-N-(4′-chloro-biphenyl-2-yl)-nicotinamide,
N-[2-(1,3-dimethylbutyl)-thiophen-3-yl]-3-trifluormethyl-1-methylpyrazol-4-ylcarboxamide,
N-(2-bicyclopropyl-2-yl-phenyl)-3-difluormethyl-1-methylpyrazol-4-ylcarboxamide,
N-(3′,4′,5′-trifluorobiphenyl-2-yl)-1,3-dimethylpyrazol-4-ylcarboxamide,
N-(3′,4′,5′-trifluorobiphenyl-2-yl)-1,3-dimethyl-5-fluoropyrazol-4-ylcarboxamide,
N-(3′,4′,5′-trifluorobiphenyl-2-yl)-5-chloro-1,3-dimethylpyrazol-4-ylcarboxamide,
N-(3′,4′,5′-trifluorobiphenyl-2-yl)-3-fluoromethyl-1-methylpyrazol-4-ylcarboxamide,
N-(3′,4′,5′-trifluorobiphenyl-2-yl)-3-(chlorofluoromethyl)-1-methylpyrazol-4-ylcarboxamide,
N-(3′,4′,5′-trifluorobiphenyl-2-yl)-3-difluoromethyl-1-methylpyrazol-4-ylcarboxamide,
N-(3′,4′,5′-trifluorobiphenyl-2-yl)-3-difluoromethyl-5-fluoro-1-methylpyrazol-4-ylcarboxamide,
N-(3′,4′,5′-trifluorobiphenyl-2-yl)-5-chloro-3-difluoromethyl-1-methylpyrazol-4-ylcarboxamide,
N-(3′,4′,5′-trifluorobiphenyl-2-yl)-3-(chlorodifluoromethyl)-1-methylpyrazol-4-ylcarboxamide,
N-(3′,4′,5′-trifluorobiphenyl-2-yl)-1-methyl-3-trifluoromethylpyrazol-4-ylcarboxamide,
N-(3′,4′,5′-trifluorobiphenyl-2-yl)-5-fluoro-1-methyl-3-trifluoromethylpyrazol-4-ylcarboxamide,
N-(3′,4′,5′-trifluorobiphenyl-2-yl)-5-chloro-1-methyl-3-trifluoromethylpyrazol-4-ylcarboxamide,
N-(2′,4′,5′-trifluorobiphenyl-2-yl)-1,3-dimethylpyrazol-4-ylcarboxamide,
N-(2′,4′,5′-trifluorobiphenyl-2-yl)-1,3-dimethyl-5-fluoropyrazol-4-ylcarboxamide,
N-(2′,4′,5′-trifluorobiphenyl-2-yl)-5-chloro-1,3-dimethylpyrazol-4-ylcarboxamide,
N-(2′,4′,5′-trifluorobiphenyl-2-yl)-3-fluoromethyl-1-methylpyrazol-4-ylcarboxamide,
N-(2′,4′,5′-trifluorobiphenyl-2-yl)-3-(chlorofluoromethyl)-1-methylpyrazol-4-ylcarboxamide,
N-(2′,4′,5′-trifluorobiphenyl-2-yl)-3-difluoromethyl-1-methylpyrazol-4-ylcarboxamide,
N-(2′,4′,5′-trifluorobiphenyl-2-yl)-3-difluoromethyl-5-fluoro-1-methylpyrazol-4-ylcarboxamide,
N-(2′,4′,5′-trifluorobiphenyl-2-yl)-5-chloro-3-difluoromethyl-1-methylpyrazol-4-ylcarboxamide,
N-(2′,4′,5′-trifluorobiphenyl-2-yl)-3-(chlorodifluoromethyl)-1-methylpyrazol-4-ylcarboxamide,
N-(2′,4′,5′-trifluorobiphenyl-2-yl)-1-methyl-3-trifluoromethylpyrazol-4-yl-carboxamide,
N-(2′,4′,5′-trifluorobiphenyl-2-yl)-5-fluoro-1-methyl-3-trifluoromethylpyrazol-4-ylcarboxamide,
N-(2′,4′,5′-trifluorobiphenyl-2-yl)-5-chloro-1-methyl-3-trifluoromethylpyrazol-4-ylcarboxamide,
N-(3′,4′-dichloro-3-fluorobiphenyl-2-yl)-1-methyl-3-trifluoromethyl-1H-pyrazole-4-carboxamide,
N-(3′,4′-dichloro-3-fluorobiphenyl-2-yl)-1-methyl-3-difluoromethyl-1H-pyrazole-4-carboxamide,
N-(3′,4′-difluoro-3-fluorobiphenyl-2-yl)-1-methyl-3-trifluoromethyl-1H-pyrazole-4-carboxamide,
N-(3′,4′-difluoro-3-fluorobiphenyl-2-yl)-1-methyl-3-difluoromethyl-1H-pyrazole-4-carboxamide,
N-(3′-chloro-4′-fluoro-3-fluorobiphenyl-2-yl)-1-methyl-3-difluoromethyl-1H-pyrazole-4-carboxamide,
N-(3′,4′-dichloro-4-fluorobiphenyl-2-yl)-1-methyl-3-trifluoromethyl-1H-pyrazole-4-carboxamide,
N-(3′,4′-difluoro-4-fluorobiphenyl-2-yl)-1-methyl-3-trifluoromethyl-1H-pyrazole-4-carboxamide,
N-(3′,4′-dichloro-4-fluorobiphenyl-2-yl)-1-methyl-3-difluoromethyl-1H-pyrazole-4-carboxamide,
N-(3′,4′-difluoro-4-fluorobiphenyl-2-yl)-1-methyl-3-difluoromethyl-1H-pyrazole-4-carboxamide,
N-(3′-chloro-4′-fluoro-4-fluorobiphenyl-2-yl)-1-methyl-3-difluoromethyl-1H-pyrazole-4-carboxamide,
N-(3′,4′-dichloro-5-fluorobiphenyl-2-yl)-1-methyl-3-trifluoromethyl-1H-pyrazole-4-carboxamide,
N-(3′,4′-difluoro-5-fluorobiphenyl-2-yl)-1-methyl-3-trifluoromethyl-1H-pyrazole-4-carboxamide,
N-(3′,4′-dichloro-5-fluorobiphenyl-2-yl)-1-methyl-3-difluoromethyl-1H-pyrazole-4-carboxamide,
N-(3′,4′-difluoro-5-fluorobiphenyl-2-yl)-1-methyl-3-difluoromethyl-1H-pyrazole-4-carboxamide,
N-(3′,4′-dichloro-5-fluorobiphenyl-2-yl)-1,3-dimethyl-1H-pyrazole-4-carboxamide,
N-(3′-chloro-4′-fluoro-5-fluorobiphenyl-2-yl)-1-methyl-3-difluoromethyl-1H-pyrazole-4-carboxamide,
N-(4′-fluoro-4-fluorobiphenyl-2-yl)-1-methyl-3-trifluoromethyl-1H-pyrazole-4-carboxamide,
N-(4′-fluoro-5-fluorobiphenyl-2-yl)-1-methyl-3-trifluoromethyl-1H-pyrazole-4-carboxamide,
N-(4′-chloro-5-fluorobiphenyl-2-yl)-1-methyl-3-trifluoromethyl-1H-pyrazole-4-carboxamide,
N-(4′-methyl-5-fluorobiphenyl-2-yl)-1-methyl-3-trifluoromethyl-1H-pyrazole-4-carboxamide,
N-(4′-fluoro-5-fluorobiphenyl-2-yl)-1,3-dimethyl-1H-pyrazole-4-carboxamide,
N-(4′-chloro-5-fluorobiphenyl-2-yl)-1,3-dimethyl-1H-pyrazole-4-carboxamide,
N-(4′-methyl-5-fluorobiphenyl-2-yl)-1,3-dimethyl-1H-pyrazole-4-carboxamide,
N-(4′-fluoro-6-fluorobiphenyl-2-yl)-1-methyl-3-trifluoromethyl-1H-pyrazole-4-carboxamide,
N-[2-(1,1,2,3,3,3-hexafluoropropoxy)-phenyl]-3-difluoromethyl-1-methyl-1H-pyrazole-4-carboxamide,
N-[4′-(trifluoromethylthio)-biphenyl-2-yl]-3-difluoromethyl-1-methyl-1H-pyrazole-4-carboxamide,
N-[4′-(trifluoromethylthio)-biphenyl-2-yl]-1-methyl-3-trifluoromethyl-1-methyl-1H-pyrazole-4-carboxamide, or
3-(difluoromethyl)-1-methyl-N-[1,2,3,4-tetrahydro-9-(1-methylethyl)-1,4-methanonaphthalen-5-yl]-1H-pyrazole-4-carboxamide.

24. The method of claim 17, which is carried out as foliar application.

25. The method of claim 17, which is carried out as seed treatment.

26. The method of claim 17, wherein one or more compounds of formula I are repeatedly applied.

27. The method of claim 17, wherein one or more compounds of formula I are applied every 10 to 20 days.

28. The method of claim 17, wherein one or more compounds of formula I are applied two to ten times during one season.

29. The method of claim 17, wherein the compound is applied to vegetables and field crops shortly after germination of the plants.

30. The method of claim 17, wherein the compound is applied to fruit crops or vegetables two to ten applications.

31. The method of claim 17, wherein the compound is applied to fruit crops or other perennial plants before the beginning of the growth period.

32. The method of claim 17, wherein a second active compound II is applied to the plants, the soil or seeds.
